(19) United States
(12) Patent Application Publication
(10) Pub. No.: US 2004/0154908 A1
(43) Pub. Date: Aug. 12, 2004

(54) Safety contact mat

(76) Inventors: Helmut Friedrich, Lippstadt (DE); Paul Meyer, Buren (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/479,825

(22) PCT Filed: Jun. 14, 2002
(86) PCT No.: PCT/DE02/02177

(30) Foreign Application Priority Data
Jun. 19, 2001 (DE) 101 29 183.3

(51) Int. Cl. H01H 3/02

(52) U.S. Cl. 200/86 R

(57) ABSTRACT

The invention relates to a safety contact mat having an upper mat half and a lower mat half with two opposite, interspaced, conductive layers, which are to be brought into contact in order to close an electrical contact. According to the invention, one mat half is formed by a flat coextrudate (1) of a non-conductive (2) elastomer, of a conductive elastomer (5), and of a conductive woven material (4) that is bordered by said elastomers (2,5).

The invention concerns a safety contact mat, which has an upper and a lower mat half with two opposing conductive layers spaced some distance apart, which are to be brought into contact to close an electrical contact.

Safety contact mats are well known and reliable. They are regularly used for the protection of output areas of machinery or similar hazardous areas that must not be walked on or driven on by persons or vehicles, etc., for safety reasons. Under a weight load, a safety contact mat of this type will, for example, close an electrical circuit, by which an emergency stop of the machinery is effected to prevent injury or damage.

To this end, safety contact mats of this type are constructed of several layers, with a bottom layer, a first conductive circuit layer applied above it, and then a second conductive circuit layer, and above that a nonconductive running layer, which is usually textured.

To meet the safety requirements, a safety contact mat must have a high degree of circuit reliability, which in practice is usually ensured by high design expense and the use of high-grade materials.

In addition to the production of safety contact mats with standard dimensions, customers often require custom manufacturing, which is associated with higher costs, since even a safety contact mat with special dimensions must be constructed at the factory.

Proceeding from this technical background, the objective of the invention is to develop a safety contact mat, which still has a simple structural design and yet guarantees high circuit reliability and can be easily made available in almost any desired dimensions.

This set of technical problems is solved by the object of claim 1, in which, in a safety contact mat, which has an upper and a lower mat half, which has two opposing conductive layers spaced some distance apart, which are to be brought into contact to close an electrical contact, one mat half consists of a flat coextrudate of a nonconductive elastomer, a conductive elastomer, and a conductive woven material enclosed by the elastomers.

By this simple means, a circuit layer is made available, which has a uniform electrical resistance over its area due to the conductive woven material. Even if the conductive elastomer happens to have a comparatively high resistance, the conductive woven material further ensures that the electrical contact is reliably closed, since the conductive woven material guarantees a uniform potential distribution over the area of the circuit layer. Due to the production as a flat coextrudate, the conductive elastomer is directly connected with the nonconductive elastomer through the conductive woven material. A reliable and durable, but also very flexible connection of these three layers is thus guaranteed.

Furthermore, the flat coextrudate with the properties described above can be rolled up due to its flexibility and is thus easy to store without it being necessary to preestablish certain dimensions, as in the case of preproduced plates.

The nonconductive elastomer can form a running surface or a base layer with an antislip surface structure in the usual way.

Both the lower mat half and the upper mat half are preferably formed by a flat coextrudate of this type, so that these mat halves are similarly designed. Different designs for the upper and lower mat halves are avoided in this way, and this greatly simplifies the construction of the safety contact mat compared to the previously known mats.

Furthermore, the mat can be turned over without any loss of function. This doubles the service life of the safety contact mat of the invention compared to state-of-the-art safety contact mats, which must be replaced when a running surface becomes damaged due to the attendant safety risks.

Since the flat coextrudate is available as meter ware, i.e., as continuous extrudate, it can be cut to almost any desired predetermined dimensions for the safety contact mat. Any desired dimensions of the safety contact mat of the invention can thus be realized in a simple way.

This is further facilitated by the fact that a width of the flat coextrudate of more than 1.00 m is provided, and especially about 1.5 m.

The thickness of the flat coextrudate is preferably less than 10 mm, and more preferably about 6 mm. Of this amount, the running layer, for example, an NBR rubber, preferably accounts for about 4 mm, while the circuit layer, which is made, for example, of a TPE, accounts for about 2 mm, with the conductive woven material enclosed between them. In this way, it is basically possible to construct safety contact mats with an extremely small thickness. For example, it is easily possible to design and construct safety contact mats with thicknesses less than 15 mm, and especially about 10 mm. However, the thickness of a flat coextrudate is also regularly determined by the future load.

In a design modification, it is possible for the conductive woven material to be a metal fabric, especially one made of high-grade steel. This measure provides not only suitable flexibility, but also mechanical stability, and high-grade steel is also sufficiently electrically conductive.

In addition to space the opposing circuit layers, individual, symmetrically mounted spacers made of a nonconductive plastic are provided in the safety contact mat of the invention. These spacers are regularly formed by sections that extend over an area and predetermine the spacing of the circuit layers. These sections have spikes that project from the top and bottom and that can be inserted into the upper or lower mat half in such a way that they cannot be removed again. By providing individual spacers, it is also possible to construct a safety contact mat with zones of different sensitivity, which can be largely predetermined by the number and spacing of the spacers.

In a further modification, one layer of the flat coextrudate can be made of a TPE. Terpolymers can also be adjusted to be electrically conductive and nonconductive. Here they offer the advantage that the outer edges of the mat half can be easily welded together, for example, by ultrasonic welding. Naturally, adhesive bonding is alternatively or additionally possible. This measure ensures that water, dirt, and the like cannot penetrate between the mat halves, and this provides high circuit reliability of the safety contact mat of the invention.

Alternatively or additionally, the outer edges of the mat halves may also be framed by a profile, which is designed with a C-shape or U-shape for this purpose. It is also conceivable for the profile and the mat halves to interlock and especially for the free legs of the profile to be provided with suitable undercuts on the upper and lower side of the mat, so that it is virtually impossible to pull the profile off transversely to its longitudinal direction.

Furthermore, to seal the outer edges of the mat halves, it is advantageous for the profile, the mat halves, and a spacer strip that runs around the edge of the mat to be bonded together with adhesive. Providing the spacer strip around the mat ensures that, even near the edge of the profile, when a load is present on the safety contact mat, the circuit surfaces make contact. In addition, this provides a high degree of protection against the penetration of water, dust, and the like through the profile around the edge and the adhesive bond and/or weld.

In a further design modification, the profile can be provided with a ramp-like design. This provides a simple means for the rollers of a cart or the like to run onto the safety contact mat.

The profile may be provided with a cable conduit, which can be used to hold the service lines of the safety contact mat or to run other cables.

In a preferred embodiment, the profile, especially a C-shaped or U-shaped profile, is made of NBR rubber, but other materials, especially EPDM or other rubbers are possible. An NBR rubber has the advantage of high resistance to oils, while TPE, for example, can be readily dyed, so that one edge of the safety contact mat can be produced in a signal color. Alternatively, the profile can be made of a metal, for example, an aluminum, especially if it is designed with a ramp.

A connecting device on the narrow side with connecting pins located one above the other can be provided for the electrical contacting of the safety contact mat. The vertical distance between the pins is set in such a way that it approximately corresponds to the vertical distance separating the two layers of conductive woven material. In particular, this measure ensures that the connecting pins will actually contact the electrically conducting woven material. This ensures a low electrical contact resistance. A connecting device of this type also allows connection anywhere along the edge.

Alternatively, a connecting device that can be placed between the conductive layers can be provided, which has vertically directed connecting pins on a nonconductive mounting plate, whose thickness corresponds to the distance separating the conductive layers in the unloaded state. A connecting device of this type also acts as a spacer. Naturally, the length of the connecting pins must be selected smaller than the thickness of the sheets of material lying above and below them. A connecting device of this type basically can also be installed at any desired place between the sheet halves.

Advantageously, it is also possible to make available a construction kit for a safety contact mat, which, in particular, has one or more of the features explained above. This construction kit includes at least one flat coextrudate of a nonconductive elastomer, a conductive elastomer, and a conductive woven material enclosed between the elastomers, as well as at least one connecting device, a spacer strip, and individual spacers.

For the first time, this gives the user the opportunity to make a safety contact mat to his/her individual specifications. To do this, it is only necessary to cut two pieces of the desired geometry from the flat coextrudate, mount the spacer strip on the edge, install a connecting device once, and place the individual spacers in suitable locations. When the edge has been sealed, for example, by adhesive bonding, the safety contact mat is finished.

In addition, in a preferred embodiment, an edge profile may be supplied with the construction kit to guarantee reliable sealing of the edge of the safety contact mat.

The invention is explained in greater detail below with reference to the drawings, in which only examples of embodiments are shown.

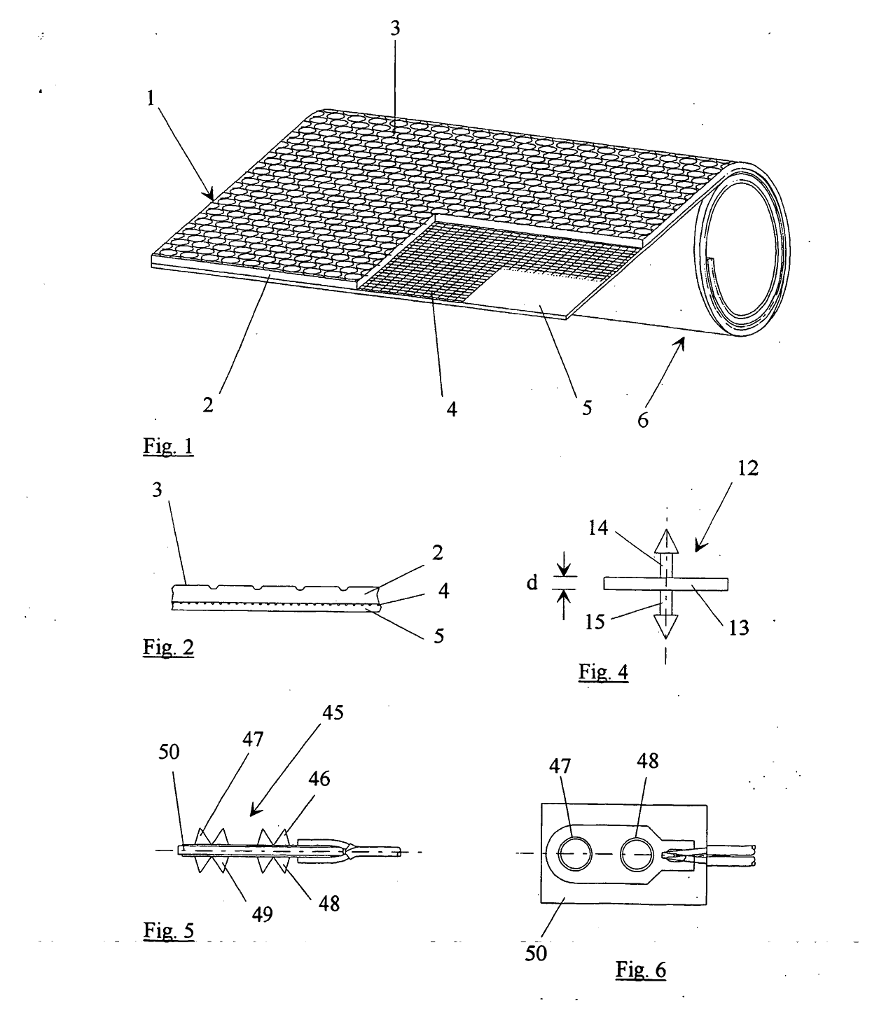

FIG. 1 shows a partially cutaway view of a flat coextrudate,

FIG. 2 shows a cross section through the flat coextrudate of FIG. 1,

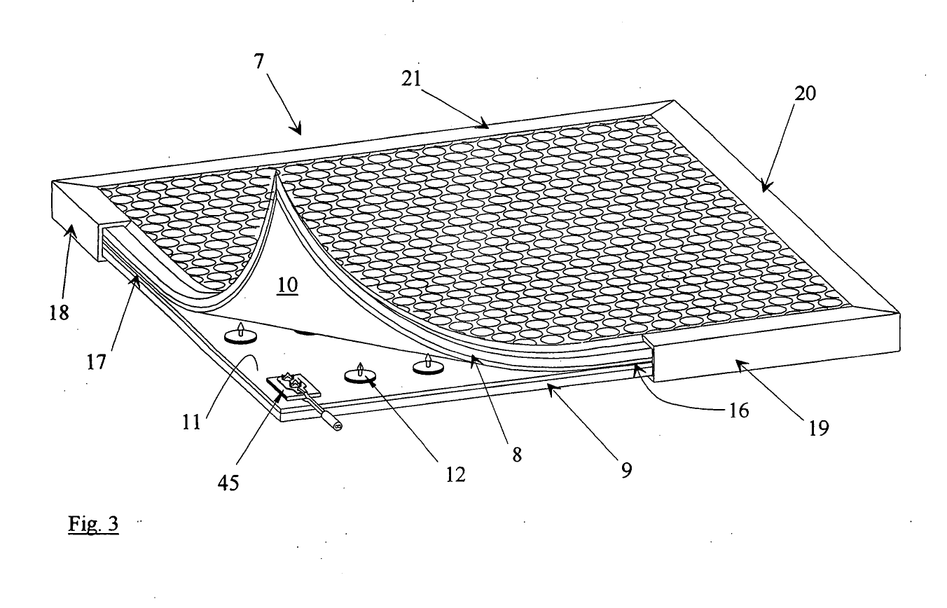

FIG. 3 shows a fabricated safety contact mat in accordance with the invention with the top half of the mat partly turned up,

FIG. 4 shows a side view of a spacer,

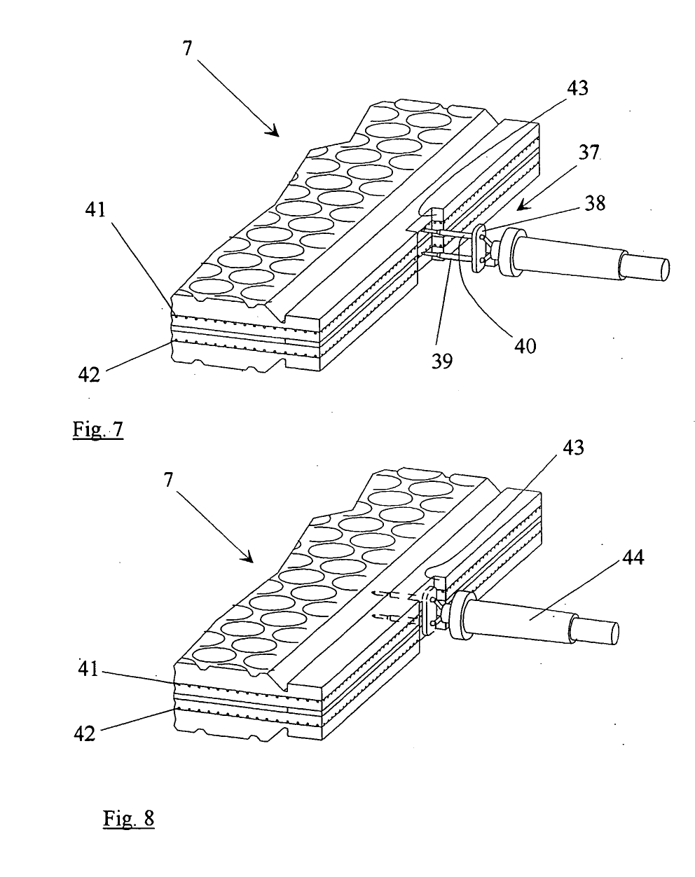

FIG. 5 shows a side view of a connecting device,

FIG. 6 shows a top view of the connecting device of FIG. 5,

FIG. 7 shows a second embodiment of a connecting device set in position at the safety contact mat,

FIG. 8 shows the connecting device of FIG. 7 inserted in a safety contact mat,

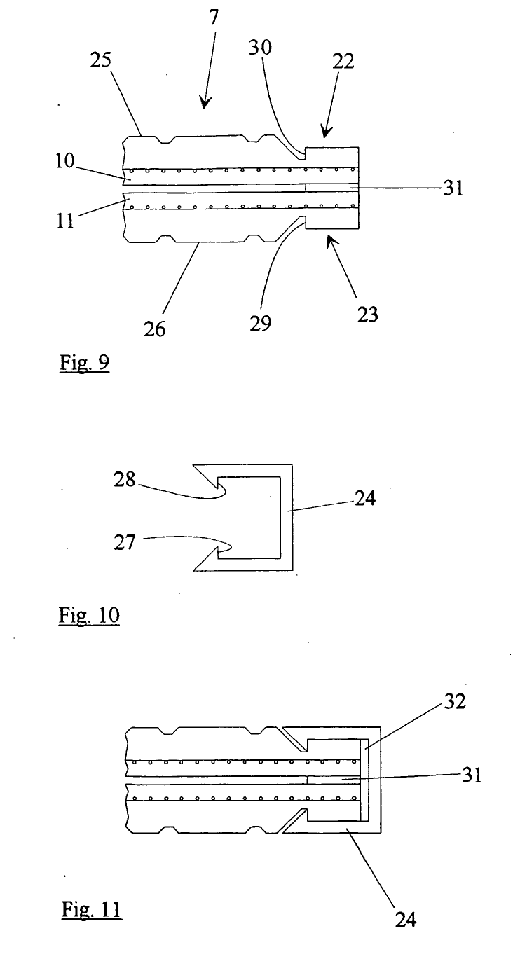

FIG. 9 shows the edge profile of a safety contact mat,

FIG. 10 shows a profile for enclosing the edge of a safety contact mat,

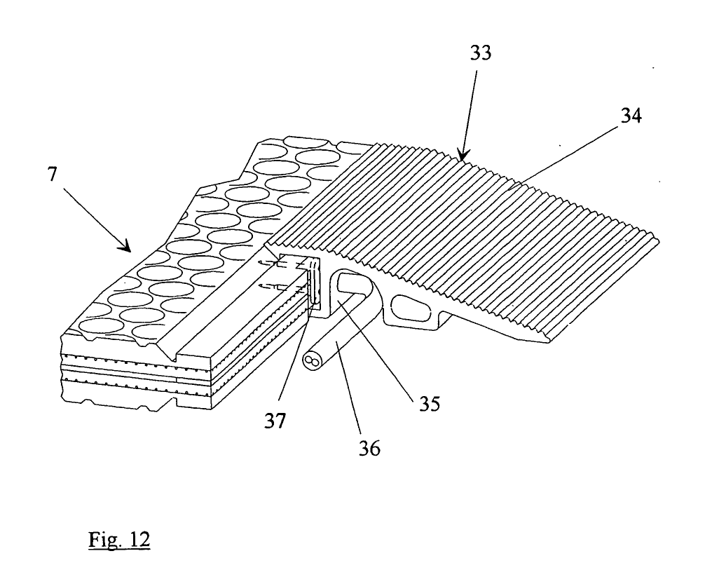

FIG. 11 shows the profile of FIG. 10 attached to a safety contact mat, and

FIG. 12 shows a second embodiment of a profile.

FIG. 1 shows a flat coextrudate 1, whose uppermost, nonconductive layer is textured by standard means as a running layer 2 with an antislip surface 3.

An electrically conductive woven material 4 is provided beneath the running layer. This electrically conductive woven material preferably consists of a metal, especially a high-grade steel.

The running layer 2 is connected with an electrically conductive circuit layer 5 lying beneath it through the woven material 4.

The running layer 2, the woven material 4, and the circuit layer 5, which consist of different materials throughout, are extruded together, and the flat coextrudate obtained in this way is sufficiently elastic that it can easily be rolled into a roll 6, shipped, and stored. A further advantage in this regard is that the roll width corresponds to the working width.

The flat coextrudate has an extremely small thickness. For example, the section through the flat coextrudate 1 shown in FIG. 2 is shown in a scale of approximately 1:1. It can be derived from this drawing that the total thickness of the flat coextrudate 1 is only about 6 mm. Of this amount, the running layer 2, which consists, for example, of an NBR rubber, accounts for 4 mm, while the circuit layer 5 accounts for about 2 mm. The woven material 4 is embedded between the circuit layer 5 and the running layer 2.

Other dimensions are perfectly possible. Of course, it should be noted that the distance from the free surface of the circuit layer 5 to the conductive fabric 4 should not be selected to be too great, so that a sufficient electric current can reliably flow.

FIG. 3 shows the design of a safety contact mat 7 of the invention. An upper mat half 8 and a lower mat half 9 are made in the same way from a flat coextrudate 1. The opposing conductive circuit layers 10, 11 are maintained a certain distance apart by individual, symmetrically designed spacers 12, which are made of a nonconductive plastic (see FIG. 4).

These spacers 12 have a middle section that extends over an area 13, shown here, for example, in the form of a circular disk, whose thickness d determines the distance separating the circuit surfaces 10, 11.

In addition, the spacers 12 are symmetrically designed here and have spikes 14, 15 projecting above and below the section 13. The height of these spikes above the section 13 is designed to be smaller than the thickness of a mat half 8, 9 formed from a flat coextrudate 1. If the spikes 14, 15 penetrate the mat halves 8, 9, their geometry causes them to lock in place, so that they cannot be pulled out.

Since the flat coextrudate 1 for the similar mat halves 8, 9 is available in the form of meter ware with almost any desired dimensions, the dimensions of the safety contact mat 7 can also be varied in almost any desired way by simple cutting.

FIG. 3 also shows the profiles 18 to 21 that enclose the edges 16, 17 of the safety contact mat 7 (cf. also FIGS. 9 to 11).

FIG. 9 shows edge-side profiling 22, 23 in a front view, which is coordinated with the cross section of profile 24 in FIG. 10. Due to the profiling 22, 23, it should be noted first that the profile 24 is not elevated above the surfaces 25, 26 of the safety contact mat 7. The profile 24, which is essentially U-shaped, has locking catches 27, 28, which engage corresponding locking recesses 29, 30 in the surface 25, 26. The profile 24 is thus prevented from being simply pulled off transversely with respect to its longitudinal direction.

In the edge region of the safety contact mat 7, the conductive layers 10 and 11 are separated by a peripheral nonconductive spacer strip 31. The spacer strip 31 is adhesively bonded and/or welded with the conductive layers 10, 11 and thus not only has a spacing function, but also serves to tightly seal the open space between the conductive layers 10, 11. If, in particular, the conductive layers 10, 11 are made of a TPE, and the spacer strip 31 is made of the same material, ultrasonic welding along the edges of these layers is also possible.

It is conceivable for the profile 24 merely to be slid on or clipped on. However, the use of an adhesive 32 and/or a sealant on the narrow side is preferred (see FIG. 11). This ensures an extremely reliable seal of the edges 16, 17 of the safety mat 7.

The profile shown in FIG. 10 may consist of almost any desired material. Plastics or metals are equally suitable. A profile made of NBR rubber has proven especially effective, since it not only has excellent oil-resistant properties, but also allows the possibility, for example, of dyeing the material with signal colors.

FIG. 12 shows another embodiment of the profile. In this case, a profile 33 is provided with a ramp 34 and thus has the ramp-like design referred to earlier. It is connected to the safety contact mat 7 in the manner explained earlier.

A special feature of the profile 33 is a cable conduit 35. In this way, a connecting cable 36 can be run to any desired place in the peripheral region of the safety contact mat 7 to establish contact by means of a connecting device 37.

Especially a profile 33 with a ramp-like design can be made of a metal, for example, aluminum, to allow greater loads.

The connecting device 37 (see also FIGS. 7 and 8) is connected to a safety contact mat 7 at the edge. It has a mounting plate 38 made of a nonconductive material, on which two horizontally oriented connecting pins 39, 40 are arranged one above the other. The vertical distance between them is dimensioned in such a way that it approximately corresponds to the vertical distance separating the layers of conductive woven material 41, 42, so that there is preferably direct contact with the layers of woven material 41, 42.

It is advantageous to place the support plate 38 in a recess 43 in the narrow side of the safety contact mat 7, so that a profile 33 can be attached without any problems (see FIG. 12).

A cable bushing 44 may possibly also be provided for traction relief and leading through profiles 33 or 24.

FIG. 3 and FIGS. 5 and 6 show another connecting device 45, which can be inserted between the conductive layers 10, 11. To this end, vertically oriented connecting pins 46 to 49 in the form of crown contacts are arranged on a nonconductive mounting plate 50. The thickness of the mounting plate 50 corresponds to the distance between the conductive layers 10, 11 in the unloaded state, so that the mounting plate also serves as a spacer.

Advantageously, both connecting devices 37 and 45 can be connected at almost any desired place between or along the edge.

The comparatively simple design of the safety contact mat 7 of the invention makes it possible to provide a user with a flat coextrudate, at least one connecting device, a spacer strip, and individual spacers in the form of a construction kit, so that he can make a safety contact mat to his own individual specifications. If necessary, a construction kit of this type can be completed with an edge profile.

1. Safety contact mat, which has an upper and a lower mat half with two opposing conductive circuit layers spaced some distance apart, which are to be brought into contact to close an electrical contact, characterized by the fact that a mat half (8, 9) consists of a flat coextrudate (1) of a nonconductive elastomer (2), a conductive elastomer (5), and a conductive woven material (4) enclosed between them.

2. Safety contact mat in accordance with claim 1, characterized by the fact that the mat halves (8, 9) have the same design.

3. Safety contact mat in accordance with one or more of the preceding claims, characterized by the fact that the flat coextrudate (1) is available as meter ware.

4. Safety contact mat in accordance with one or more of the preceding claims, characterized by the fact that the flat coextrudate (1) has a width of more than 1.00 m.

5. Safety contact mat in accordance with one or more of the preceding claims, characterized by the fact that the thickness of the flat coextrudate (1) is less than 10 mm.

6. Safety contact mat in accordance with one or more of the preceding claims, characterized by the fact that the conductive woven material (4) is a metal fabric.

7. Safety contact mat in accordance with one or more of the preceding claims, characterized by the fact that the metal is a high-grade steel.

8. Safety contact mat in accordance with one or more of the preceding claims, characterized by the fact that the conductive circuit layers (10, 11) are maintained a certain distance apart by individual, symmetrically designed spacers (12), which are made of a nonconductive material.

9. Safety contact mat in accordance with one or more of the preceding claims, characterized by the fact that one layer of the flat coextrudate (1) is made of a TPE.

10. Safety contact mat in accordance with one or more of the preceding claims, characterized by the fact that the outer edges (16, 17) of the mat halves (8, 9) are welded together and/or adhesively bonded together.

11. Safety contact mat in accordance with one or more of the preceding claims, characterized by the fact that the outer edges (16, 17) of the mat halves (8, 9) are enclosed by a profile (18-21).

12. Safety contact mat in accordance with one or more of the preceding claims, characterized by the fact that the profile (24) and the mat halves (8, 9) interlock with each other.

13. Safety contact mat in accordance with one or more of the preceding claims, characterized by the fact that the profile (24), the mat halves (8, 9), and a spacer strip (31) that runs around the edge of the mat (7) are bonded together with adhesive.

14. Safety contact mat in accordance with one or more of the preceding claims, characterized by the fact that the profile (33) has a ramp-like design.

15. Safety contact mat in accordance with one or more of the preceding claims, characterized by the fact that the profile (33) has a cable conduit (35).

16. Safety contact mat in accordance with one or more of the preceding claims, characterized by the fact that the profile consists of an NBR rubber.

17. Safety contact mat in accordance with one or more of the preceding claims, characterized by the fact that the profile consists of a metal.

18. Safety contact mat in accordance with one or more of the preceding claims, characterized by the fact that a connecting device (37) with horizontally oriented connecting pins (39, 40) located vertically one above the other can be provided for an electrical connection on the narrow side, such that the vertical distance between the pins is set in such a way that it approximately corresponds to the vertical distance separating the two layers of conductive woven material (41, 42).

19. Safety contact mat in accordance with one or more of the preceding claims, characterized by the fact that a connecting device (45) is provided, which can be inserted between the conductive layers (10, 11) and has vertically oriented connecting pins (46-49) on a nonconductive mounting plate (50), whose thickness corresponds to the distance between the conductive layers (10, 1 1) in the unloaded state.

20. Construction kit for a safety contact mat, especially in accordance with one or more of the preceding claims, which has at least one flat coextrudate (1) of a nonconductive elastomer, a conductive elastomer, and a conductive woven material enclosed between the elastomers, as well as at least one connecting device (37, 45), a spacer strip (31), and individual spacers (12).

21. Construction kit in accordance with claim 19, which also has an edge profile (24, 33).
